(19) United States
(12) Patent Application Publication
(10) Pub. No.: US 2006/0097498 A1
(43) Pub. Date: May 11, 2006

(54) Gas bag module

(75) Inventors: Michael Schneider, Sulzbach (DE); Ralph Frisch, Moembris (DE); Andreas Kienzner, Wiesen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/258,339

(22) Filed: Oct. 25, 2005

(30) Foreign Application Priority Data
Nov. 10, 2004 (DE) 20 2004 017 429.4

(51) Int. Cl. B60R 21/30

(52) U.S. Cl. 280/739

(57) ABSTRACT

A gas bag module for a vehicle occupant restraint device includes a gas generator for inflating a gas bag, at least one discharge opening formed in a rigid component of the gas bag module, through which discharge opening gas generated by the gas generator and directed into the gas bag can be discharged, and at least one valve flap which in a closing position closes the discharge opening and in an opening position frees the discharge opening. At least one temperature-sensitive blocking element is provided which can block the valve flap in the closing position as a function of temperature.

### TECHNICAL FIELD

The invention relates to a gas bag module for a vehicle occupant restraint device, with a gas generator for inflating a gas bag, at least one discharge opening formed in a rigid component of the gas bag module, through which discharge opening gas generated by the gas generator and directed into the gas bag can be discharged, and at least one valve flap which in a closing position closes the discharge opening and in an opening position frees the discharge opening.

### BACKGROUND OF THE INVENTION

Usually, in a gas bag module, the gas bag is to be inflated as quickly as possible with the gas generated by the gas generator. In particular cases it is, however, desirable not to inflate the gas bag with the entire gas volume which is available, or, more generally, to discharge gas, for which reason discharge openings are provided in the gas bag module, by the freeing of which the pressure in the gas bag can be limited.

US 2004/0051285 A1 discloses a gas bag module of the type initially mentioned, in which the valve flaps, which can close or free two discharge openings formed in a gas generator carrier, are connected by means of tethers with a part of the gas bag fabric facing a vehicle occupant. In a case of restraint, the valve flaps at first are in the outwardly directed opening position. The gas bag is therefore not inflated with the entire gas volume which is available. If the deploying gas bag now comes into contact with the vehicle occupant before the gas bag has deployed so far that the tethers are tensioned, then the discharge openings remain open. Thereby, the pressure of the deploying gas bag and hence the force exerted onto the vehicle occupant is reduced. If the vehicle occupant is in a position which is further away from the gas bag module, then the gas bag likewise deploys, as described above, at first slowly with opened discharge openings. However, as soon as the gas bag has deployed so far that the tethers are tensioned, the latter draw the valve flaps inwards, whereby the discharge openings are closed against the internal pressure of the gas bag. Therefore, no or only a little amount of gas is discharged through the discharge openings, and the entire gas volume is used for inflating the gas bag.

Furthermore, it is considered to construct the gas bag module just described such that the valve flaps in the non-triggered state of the gas bag are initially closed and only open in the case of triggering owing to the increasing pressure in the interior of the gas bag.

A disadvantage in the solution described hitherto is that basically in the initial phase of the deploying of the gas bag, a portion of the gas generated by the gas generator escapes through the discharge openings. This is, however, not desired in the case of very low temperatures below −10 degrees Celsius, because in this case the entire gas provided by the gas generator is required for the deploying of the gas bag.

U.S. Pat. No. 5,695,214 proposes a gas bag module in which several discharge openings arranged in a module housing are freed in that a flap-like closure element is brought from a closed into an opened position. Here, the closure element in the closed position is fixedly connected with the module housing by means of a separation bolt. Several sensors are provided which determine the position of a vehicle occupant, his size, the severity of the impact and also the ambient temperature. In a case of triggering of the gas bag, the separation bolt is activated as a function of these parameters, in order to free the discharge openings. Such a system with an electronic sensor arrangement is, however, comparatively complex and therefore expensive.

It is therefore an object of the present invention to refine the gas bag module known from US 2004/0051285 A1 in a simple and hence favorably priced manner to the effect that in a case of restraint, optionally, dependent on the ambient temperature, the entire gas generated by the gas generator can be used for deploying the gas bag.

### BRIEF SUMMARY OF THE INVENTION

This is achieved in a gas bag module for a vehicle occupant restraint device, comprising a gas generator for inflating a gas bag, at least one discharge opening formed in a rigid component of the gas bag module, through which discharge opening gas generated by the gas generator and directed into the gas bag can be discharged, and at least one valve flap which in a closing position closes the discharge opening and in an opening position frees the discharge opening. At least one temperature-sensitive blocking element is provided which can block the valve flap in the closing position as a function of temperature.

Thereby it is ensured in a simple and reliable manner that no, or only very little gas escapes through the discharge opening when the blocking element is activated. Thus the entire gas volume provided by the gas generator can be used for the deploying of the gas bag. On the other hand, when the blocking element is not active, a fast acting venting mechanism is realized by the valve flap which abruptly opens in response to an internal pressure of the gas bag and which can, in an embodiment with tethers, rapidly be closed. This venting mechanism, unlike a valve element in the form of a sliding plate, does not include any inert parts.

Since in the case of low temperatures below −10 degrees Celsius the gas generated by the gas generator has a distinctly lower pressure than at higher temperatures, the blocking element is preferably constructed to block the valve flap in the closing position at low temperatures and to free the valve flap at higher temperatures. In this way, a rapid deploying of the gas bag is achieved at low temperatures as well.

According to a preferred embodiment, the blocking element is a part of a mechanical blocking device which operates without a separate energy source and is therefore able to be produced at a particularly favorable cost and is scarcely liable to break down. The blocking element represents, in general terms, a type of drive for a blocking device. This solely temperature-dependent blocking device and the opening mechanism formed by the flap (and, optionally, a tether), which opening mechanism responds to an internal pressure of the gas bag module, represent two basically independent systems. However, the blocking device can prevent the opening mechanism from operating.

The blocking element is advantageously arranged on the rigid component of the gas bag module in a region of the discharge opening, whereby a stable arrangement is produced. Of course, the blocking element could also be a component of the flap.

The blocking element can have a temperature-dependent stress-strain behavior through which the blocking element can represent a drive for at least one of blocking and freeing the valve flap. The mode of operation of the blocking element is therefore based exclusively on a material characteristic and is therefore particularly reliable and not liable to break down.

According to a further embodiment, the blocking element has a thermal expansion through which the blocking element represents a drive for at least one of blocking and freeing the valve flap. Again, a pure material characteristic is used in order to provide a reliable blocking mechanism.

Advantageously, the blocking element comprises a snap hook which embraces a projection mounted on the valve flap. At low temperatures, the snap hook prevents, through its rigidity, an opening of the valve flap. At higher temperatures, the material of the snap hook is “softer”, therefore a lower force for opening the valve flap is necessary, which can be applied by the internal pressure of the gas bag. In this way, a simple, favorably priced and nevertheless very effective blocking device is obtained. Vice versa, the projection could also embrace the snap hook.

The blocking element can comprise a web which connects the valve flap with the rigid component of the gas bag module. The web here consists of a material which is more resistant at low temperatures than at increased temperatures. Thereby, the valve flap is held in its closing position at low temperatures. At higher temperatures, the web can break owing to the force which is applied onto the valve flap by the internal pressure of the gas bag, and the valve flap opens. Again, a simple and effective blocking mechanism is produced.

According to a further embodiment, the blocking element has a resiliently pre-stressed, displaceable locking element which is arranged in a guide mounted on the rigid component of the gas bag module. The locking element preferably consists of a material having a lower coefficient of thermal expansion than the guide. The locking element and the guide are advantageously coordinated with each other so that the locking element is clamped in the guide at low temperatures, whereby the valve flap is blocked in the closing position. At higher temperatures, the locking element can be displaced in the guide by the force exerted onto the valve flap, so that with a sufficiently high internal pressure of the gas bag, an opening of the valve flap is possible. This embodiment of the blocking device therefore also represents a simple mechanical system which is not liable to break down.

According to a further embodiment, the blocking element comprises a bimetal spring. This bimetal spring is constructed so that it prevents an opening of the valve flap at low temperatures and is distinguished by its simplicity and effectiveness.

### BRIEF DESCRIPTION OF THE DRAWINGS

FIG. 1 shows a half-section of a vehicle steering wheel with a gas bag module according to a first embodiment of the invention;

FIG. 2 shows a bottom view of a generator carrier of a gas bag module in accordance with the first embodiment of the invention;

FIG. 3 shows a bottom view of a generator carrier of a gas bag module in accordance with a second embodiment of the invention;

FIG. 4 shows an enlarged detail sectional view of a third embodiment of a gas bag module according to the invention; and

FIG. 5 shows an enlarged detail sectional view of a gas bag module in accordance with a fourth embodiment of the invention.

### DETAILED DESCRIPTION OF THE PREFERRED EMBODIMENTS

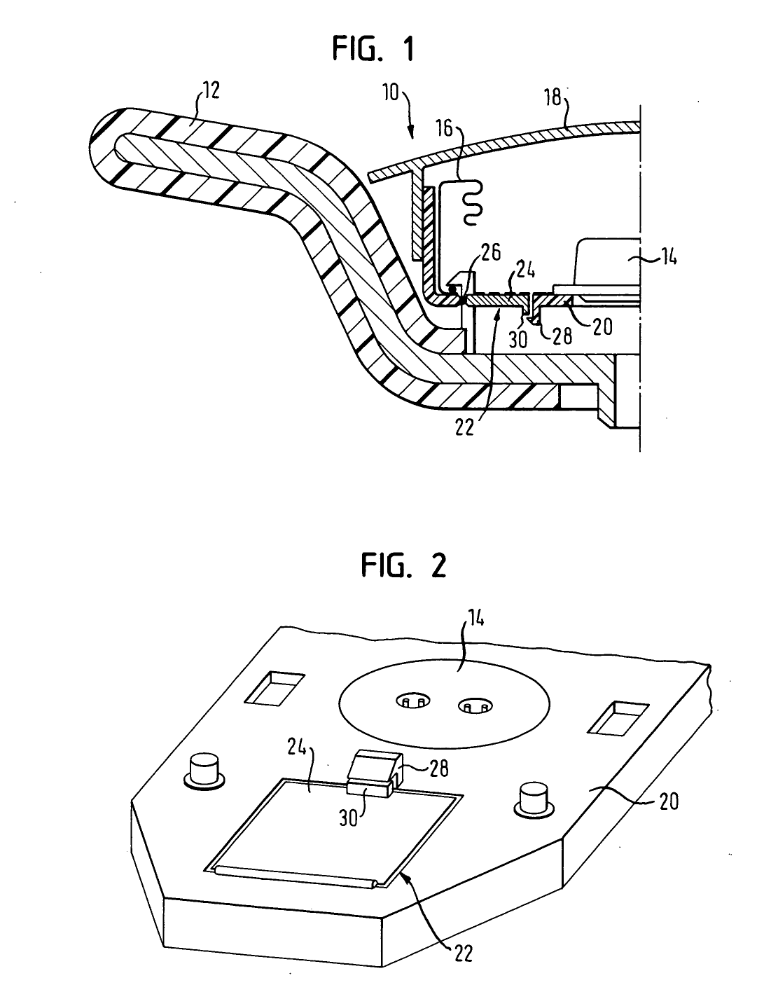

FIG. 1 shows a gas bag module 10 which is particularly intended for a driver's gas bag module, but is not restricted thereto. As a driver's gas bag module, the module 10 preferably forms a part of a steering wheel 12. The gas bag module 10 has a gas generator 14 and a gas bag 16 which is only indicated in the figure, and is delimited by a covering cap 18 directed towards a vehicle occupant in a non-triggered state. In a rigid component of the gas bag module 10 in the form of a generator carrier 20, a discharge opening 22 is provided which is closed by means of a valve flap 24. The discharge opening 22 and the valve flap 24, in this way, form a valve for delimiting the internal pressure of the gas bag. The valve flap 24 can be constructed in one piece with the generator carrier 20 or can be connected therewith via a hinge 26. The gas bag 16 has an outflow opening in the region of the valve flap 24, or the gas bag 16 is fastened to the module laterally outside the valve flap 24. In order to enable a variable inflation of the gas bag 16 depending on a seating position of the vehicle occupant, the vent flap 24 can be connected via a tether (not represented in the drawing) to a wall section of the gas bag 16 facing the occupant, as described in US 2004/0051285 A1.

As can best be seen from FIG. 2, in the region of the discharge opening 22 the generator carrier 20 has a snap hook 28 which embraces a projection 30 mounted on the valve flap 24. Of course, the snap hook 28 can also be arranged on a different rigid component of the gas bag module 10, for example on a gas bag retaining element or else on the valve flap 24 itself.

The snap hook 28 represents a blocking element, the mode of operation of which is based on the following operating principle. The material of the snap hook 28, which is preferably plastic but with other materials also being conceivable, has different material characteristics at different temperatures. Thus, in particular, the stress-strain behavior at very low temperatures is different from the one at room temperature, for example, or at higher temperatures. The snap hook 28 is constructed so that at low temperatures it displays a particularly rigid behavior, whereby in a case of triggering of the gas bag 16, an opening of the valve flap 24, brought about by the internal pressure of the gas bag, is prevented. At room temperature or at higher positive temperatures, the material of the snap hook 28 is “softer” than at negative temperatures, which is why a lower force is sufficient to open the valve flap 24. At higher temperatures, an opening of the valve flap 24 is made possible owing to the internal pressure of the gas bag in the case of triggering.

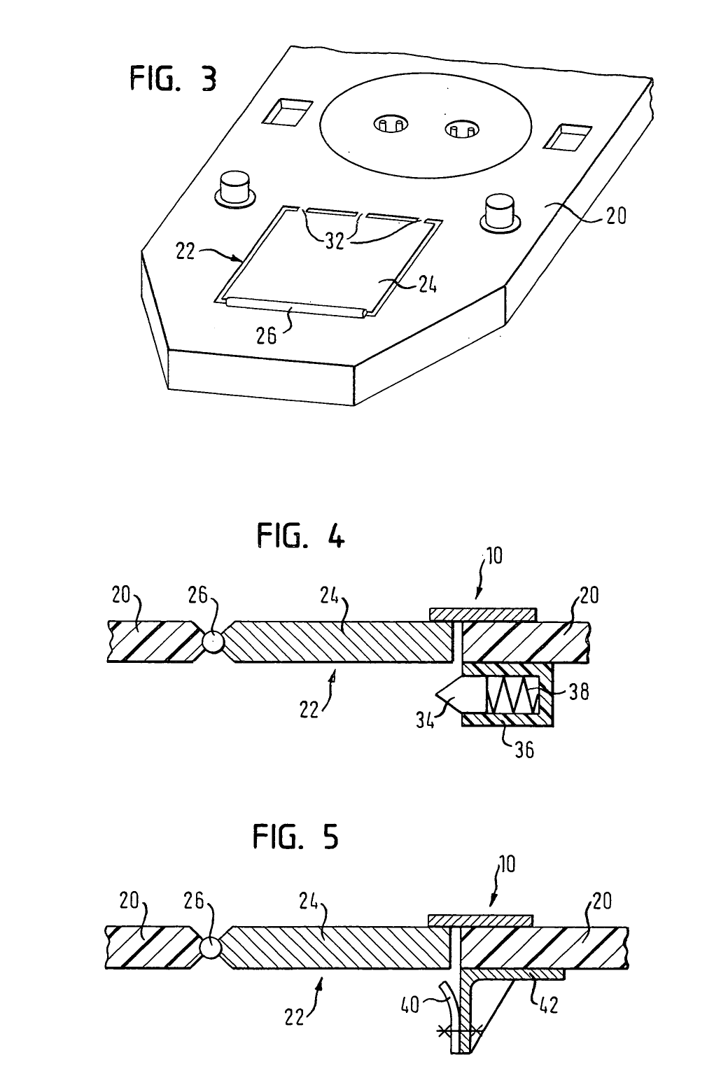

FIG. 3 shows a generator carrier 20 according to a second embodiment of the gas bag module 10, with identical components having identical reference numbers and with only the differences between the embodiments being entered into detail below. Instead of a snap hook, in the assembly according to FIG. 3 provision is made that the valve flap 24 is connected with the generator carrier 20 via several webs 32. Here, both the valve flap 24 and also the generator carrier 20 are made from plastic.

The webs 32 again consist of a material which displays a temperature-dependent stress-strain behavior and are constructed such that they are more resistant at low temperatures than at higher temperatures. Thereby, the webs 32 block the valve flap 24 in its closing position at low temperatures, whereas at higher temperatures the webs 32 break relatively easily and the valve flap 24 can open owing to the internal pressure of the gas bag.

The embodiments shown in FIGS. 4 and 5 are based on an operating principle which differs slightly from that of the first two embodiments. Whereas in the embodiments described hitherto, the temperature-dependent stress-strain behavior of the material from which the blocking elements are produced was used, the blocking devices in the embodiments of the gas bag module 10 shown in FIGS. 4 and 5 are based on the thermal expansion with a change in temperature.

FIG. 4 shows a cut-out of a gas bag module 10 in side view, in which the valve flap 24, which is movable about the hinge 26, is held in the closed position by means of a blocking element in the form of a locking element 34. The locking element 34 is arranged in a guide 36 mounted on the generator carrier 20 and is connected therewith via a pre-stressed spring 38.

The locking element 34 and the guide 36 consist of different materials, the material of the locking element 34 having a lower coefficient of thermal expansion than the material of the guide 36. The blocking device formed by the locking element 34 and the guide 36 is constructed such that the locking element 34 is clamped in the guide 36 at low temperatures. Thus, at these temperatures an opening of the valve flap 24 is prevented. At higher temperatures, owing to its greater coefficient of thermal expansion, the guide 36 expands more intensively than the locking element 34, whereby the clamping is discontinued and the locking element 34 can slide in the guide 36. Thus, the valve flap 24 can be opened by the internal pressure of the gas bag in the case of triggering.

In the gas bag module 10 shown in FIG. 5, a bimetal spring 40 is used as blocking element, which is connected with the generator carrier 20 via a fastening element 42 in the region of the discharge opening 22. The bimetal spring 40 is constructed so that, as shown in FIG. 5, it prevents an opening of the valve flap 24 at low temperatures owing to its slightly bent shape and its arrangement underneath the valve flap 24. At higher temperatures the bimetal spring 40 deforms so that it lies with its upper end against the vertical part of the fastening element 42, whereby an opening of the valve flap 24 is made possible.

In all the embodiments, the valve flap 24 is blocked below a predetermined temperature threshold, which lies below −10 degrees Celsius.

1. A gas bag module for a vehicle occupant restraint device, said gas bag module comprising a gas generator (14) for inflating a gas bag (16), at least one discharge opening (22) formed in a rigid component of said gas bag module (10), through which discharge opening (22) gas generated by said gas generator (14) and directed into said gas bag (16) can be discharged, at least one valve flap (24) which in a closing position closes said discharge opening (22) and in an opening position frees said discharge opening (22), and at least one temperature-sensitive blocking element which can block said valve flap (24) in said closing position as a function of temperature.

2. The gas bag module according to claim 1, wherein said blocking element is constructed to block said valve flap (24) in said closing position at low temperatures and to free said valve flap (24) at higher temperatures.

3. The gas bag module according to claim 1, wherein said blocking element is a part of a mechanical blocking device operating without a separate energy source.

4. The gas bag module according to claim 1, wherein said blocking element is arranged on said rigid component of said gas bag module (10) in a region of said discharge opening (22).

5. The gas bag module according to claim 1, wherein said blocking element has a temperature-dependent stress-strain behavior through which said blocking element represents a drive for at least one of blocking and freeing said valve flap (24).

6. The gas bag module according to claim 1, wherein said blocking element has a thermal expansion through which said blocking element represents a drive for at least one of blocking and freeing said valve flap (24).

7. The gas bag module according to claim 1, wherein said blocking element comprises a snap hook (28) which embraces a projection (30) mounted on said valve flap (24).

8. The gas bag module according to claim 1, wherein said blocking element comprises a web (32) which connects said valve flap (24) with said rigid component of said gas bag module (10).

9. The gas bag module according to claim 1, wherein said blocking element has a resiliently pre-stressed displaceable locking element (34) which is arranged in a guide (36) mounted on said rigid component of said gas bag module (10).

10. The gas bag module according to claim 9, wherein said locking element (34) consists of a material having a lower coefficient of thermal expansion than said guide (36).

11. The gas bag module according to claim 9, wherein said locking element (34) and said guide (36) are coordinated with each other so that said locking element (34) is clamped in said guide (36) at low temperatures.

12. The gas bag module according to claim 1, wherein said blocking element comprises a bimetal spring (40).

13. The gas bag module according to claim 1, wherein said blocking element blocks said valve flap (24) in said closing position below a predetermined temperature threshold value which lies below −10 degrees Celsius.
